(19) United States
(12) Patent Application Publication
(10) Pub. No.: US 2019/0331429 A1
(43) Pub. Date: Oct. 31, 2019

(54) PIPE HEATING SYSTEM FOR AN AIRCRAFT

(71) Applicant: Airbus Operations GmbH, Hamburg (DE)

(72) Inventors: Peter LINDE, Hamburg (DE); Matthias HEGENBART, Hamburg (DE)

(21) Appl. No.: 16/390,100

(22) Filed: Apr. 22, 2019

(30) Foreign Application Priority Data
Apr. 27, 2018 (DE) 102018003436.5

(51) Int. Cl. F28D 15/02; H05B 3/56

(52) U.S. Cl. CPC F28D 15/0241; H05B 3/56

(57) ABSTRACT

A heatable water pipe for an aircraft, having a heat-generating ply which extends in the pipe circumferential direction and the pipe longitudinal direction, at least in some section or sections. The heat-generating ply comprises a fiber composite layer containing fibers and a matrix surrounding the fibers, wherein at least some of the fibers are formed as conducting fibers. In this context, the conducting fibers are formed as carbon fibers with an electrically insulating coating. By virtue of the electrically insulating coating, leakage currents can be avoided. The carbon fibers serve both as heating elements and as reinforcing fibers in the fiber composite layer.

### CROSS-REFERENCES TO RELATED APPLICATIONS

This application claims the benefit of the German patent application No. 10 2018 003 436.5 filed on Apr. 27, 2018, the entire disclosures of which are incorporated herein by way of reference.

### FIELD OF THE INVENTION

The invention relates to a heatable pipe, in particular a water pipe, for an aircraft and to a pipe heating system for an aircraft.

### BACKGROUND OF THE INVENTION

Systems in aircraft used for commercial purposes include pipes for water, hydraulic oil or air. It is important that fluids which are carried through the pipes are transferred at the temperature which is appropriate in each case. This can be a challenge, particularly in unheated areas of an aircraft, during flight or even on the ground in cold weather. The water-carrying lines must not fall below the freezing point, for example. Known solutions propose to heat pipes of this kind by means of electric resistance cables, for example.

Although these solutions are effective in principle, they are associated both with a certain financial outlay and also with a not insignificant effort for installation. Moreover, by their very nature, the heating effect is not restricted to the areas of the pipe in which the resistance cables are laid and are in contact with the pipe.

### SUMMARY OF THE INVENTION

It is an object of the present invention to provide an improved solution for heating pipes used in aircraft, especially water pipes used in aircraft.

This object of the invention is achieved by a heatable pipe, in particular by a water pipe, for an aircraft, comprising a heat-generating ply, which extends in the pipe circumferential direction and the pipe longitudinal direction, at least in some section or sections, wherein the heat-generating ply comprises a fiber composite layer containing fibers and a matrix surrounding the fibers, wherein at least some of the fibers are designed as conducting fibers, and wherein the conducting fibers are formed as carbon fibers with an electrically insulating coating. One concept underlying the present invention is to use coated carbon fibers as electric conductors for a heatable pipe or for a pipe heating system. According to the invention, the conducting fibers are integrated into the heatable pipe, wherein a power source can be applied to the end of the fibers in order to pass a heating current through the fibers. By virtue of the electrically insulating coating of the conducting fibers, leakage currents or similar effects can be completely avoided since the insulated fibers can easily come into contact without this leading to a leakage current. Such coatings of carbon fibers can be produced at relatively low cost and in a manner which is efficient in terms of time, with a high temperature stability of up to 700 degrees Celsius and above, even in mass production. Another advantage of the invention results from the fact that the carbon fibers of the conducting fibers can serve directly as reinforcing fibers for the fiber composite layer and, as it were, form an integral part of the fiber composite layer without leading to discontinuities or electrochemical reactions. The electrically insulating coating can furthermore be chosen in such a way that there is no impairment of the bonding behavior, i.e., the conducting fibers have a similar bonding behavior to that of uncoated carbon fibers.

In principle, the conducting fibers can be processed and handled during fiber composite production in precisely the same way as conventionally employed uncoated carbon fibers. Moreover, the conducting fibers can even act directly as reinforcing fibers for the fiber composite component.

Not all the fibers of the pipe according to the invention have to be designed as conducting fibers, i.e., as carbon fibers with an electrically insulating coating. It is also possible for just a certain proportion of the fibers to be formed as conducting fibers in the fiber composite layer and for another portion of the fibers to be conventional, i.e., to be designed as non-current-carrying fibers, for example (i.e., without an insulating coating and/or in the form of an electrically nonconductive glass fiber). In general, the conducting fibers according to the invention are massive or solid fibers (i.e., with a continuous conductor cross section). In principle, however, it is also possible to conceive of conducting fibers which have a cavity along their fiber longitudinal direction (hollow fibers).

In addition to the heat-generating ply comprising the conducting fibers, the pipe according to the invention generally also has a basic pipe structure. The basic pipe structure can comprise a plurality of fiber composite layers of conventional design, for example. In addition to the fiber composite layer comprising the conducting fibers, three or more further unidirectional fiber composite layers can form the basic pipe structure, for example. In principle, depending on which fluid is to be transferred through the pipe according to the invention (e.g., water, air or an oil), some other construction of the basic pipe structure may of course also be considered. In addition to the basic pipe structure, insulating layers or supporting layers are also conceivable, for example. Supporting layers can comprise a honeycomb structure, for example. Such honeycomb structures impart an additional structural strength. It is self-evident that, in addition to a honeycomb structure of this kind, further fiber composite structures, such as one or more further fiber composite layers (e.g., prepregs etc.) can be provided on one or both sides of the honeycomb structure in order to ensure additional strength.

The heatable pipe designed in accordance with the invention provides a multifunctional, lightweight water pipe for use in commercial aircraft, particularly in unheated areas of commercial aircraft. By virtue of the relatively small number of individual components, the pipe according to the invention can furthermore be produced or manufactured easily and quickly. In this form, the installation of a conventional separate heating cable system is not necessary. The direct integration of the heating capability into the pipe allows quick and easy installation. There are also advantages with the pipe according to the invention in terms of costs and weight. Moreover, the pipe according to the invention with integrated heating capability advantageously requires little installation space. In principle, the pipe according to the invention can carry any fluid or medium. Pipes designed in accordance with the invention can be suitable for carrying air, water or a hydraulic oil, for example.

In a preferred embodiment, the conducting fibers form one or more closed circuits. Thus, a heating current can be passed through the conducting fibers in a manner which is advantageous and is in accordance with the invention. By means of the electrically insulating coating, leakage currents are avoided. The insulated fibers can easily come into contact without the occurrence of a short circuit.

There is also a preference for an embodiment in which the form of the arrangement of the conducting fibers in the fiber composite layer is selected from the group comprising: individual fibers, fiber bundles, fiber ribbons, non-crimped fibers, fiber mats, woven fibers and nonwoven fibers. The conducting fibers according to the invention can be arranged or integrated in various ways. In principle, the heating function according to the invention of the conducting fibers advantageously remains independent of the form of arrangement of the conducting fibers.

In a likewise preferred embodiment, the conducting fibers are aligned in a unidirectional manner. In this way, a particularly direct heating effect, i.e., a particularly direct output of the quantity of heat energy via the thermally conductive layer to the fluid to be heated (e.g., water, air or an oil), is possible. As is known, unidirectional layers in fiber composite plastics furthermore have advantages in respect of their stiffness and strength.

There is also a preference for an embodiment in which the conducting fibers are arranged parallel to the pipe longitudinal direction. In this way, it is possible, in principle, for there to be locally limited heat transfer to the fluid to be heated, namely in a manner limited to a certain section or sections in the pipe circumferential direction but, at the same time, continuous in the pipe longitudinal direction.

In a likewise preferred embodiment, the heat-generating ply is arranged on a pipe inner side. Arranging the heat-generating ply on the pipe inner side enables particularly direct and effective transfer of the heat generated in the conducting fibers to the fluid to be transferred and heated (e.g., water, air or oil).

The electrically insulating coating preferably has a thickness in a range of from 0.1 micrometer to 1 micrometer. In particular, the electrically insulating coating can have a thickness of 0.5 micrometers. The electrically insulating coating completely surrounds the carbon fibers of the conducting fibers. In other words: the electrically insulating coating is applied to the carbon fibers. The carbon fibers can have a diameter of between 6 and 7 micrometers, for example, giving a diameter of the conducting fibers of about 7 to 8 micrometers.

In a likewise preferred embodiment, the conducting fibers are integrated into the fiber composite layer in such a way that the conducting fibers protrude from the fiber composite layer at the beginning of the pipe or at the end of the pipe. By virtue of the fact that the conducting fibers project beyond the fiber composite layer at the start of the pipe or at the end of the pipe, i.e., at the respective ends thereof, a power source can be connected to the ends in a simple manner.

There is also a preference for an embodiment in which the electrically insulating coating is formed as a polymer electrolyte coating. In particular, the coating can be formed as a solid polymer electrolyte coating. The polymer electrolyte coating can contain a methoxy polyethylene glycol monomethacrylate, for example. Polymer electrolyte coatings of this kind can have a temperature stability of at least 700 degrees Celsius but, at the same time, can have excellent bonding properties for incorporation into fiber-reinforced components, e.g., into a thermoplastic reinforced with carbon fibers.

This object of the invention is furthermore achieved by a pipe heating system for an aircraft, having a heatable pipe according to the invention and a power source for supplying electric heating power, wherein the power source is connected electrically to the pipe, in particular to the closed circuit or circuits. The pipe heating system according to the invention makes use of essentially the same advantages as the heatable pipe according to the invention.

In a preferred embodiment of the pipe heating system, the pipe heating system furthermore has a control unit, which comprises temperature sensors and by means of which the heating power of the power source can be controlled. In this way, the current passed through the conducting fibers can be continuously adapted if there is any deviation from a predetermined or desired target temperature.

Finally, an aircraft having a pipe heating system according to the invention is preferred. The aircraft according to the invention makes use of essentially the same advantages as the heatable pipe according to the invention or the pipe heating system according to the invention.

The above-described aspects and further aspects, features and advantages of the invention can likewise be taken from the examples of the embodiment which is described below with reference to the attached drawings.

### BRIEF DESCRIPTION OF THE DRAWINGS

In the figures, identical reference signs are used for identical or at least similar elements, components or aspects. It is observed that the embodiment described in detail below is merely illustrative and not restrictive. In the claims, the word “having” does not exclude other elements and the indefinite article “a/an” does not exclude a plurality. The mere fact that certain features are mentioned in different dependent claims does not restrict the subject matter of the invention. Combinations of these features can also be employed to advantage. The reference signs in the claims are not intended to limit the scope of the claims. The figures should not be interpreted as being to scale and have only a schematic and illustrative character. In the drawing:

FIG. 1 shows a perspective view of a heatable pipe according to the invention,

FIG. 2 shows a perspective view of a conducting fiber according to the invention,

FIG. 3 shows a plan view of a pipe heating system according to the invention having a heat-generating ply which, by way of example, is rolled up, and

FIG. 4 shows an aircraft which has a pipe according to the invention or a pipe heating system according to the invention.

### DETAILED DESCRIPTION OF THE PREFERRED EMBODIMENTS

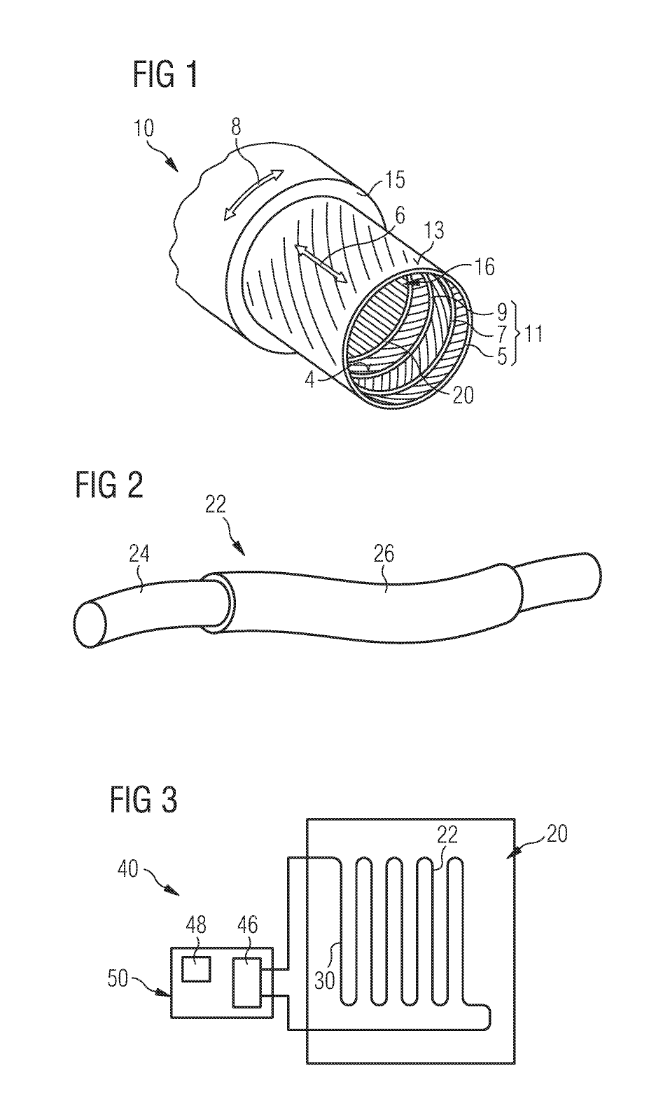

FIG. 1 shows a heatable pipe 10 for an aircraft. The pipe 10 has a heat-generating ply 16, which is arranged on a pipe inner side 4. In addition to the heat-generating ply 16, the pipe 10 according to the invention generally also has a basic pipe structure 11. In FIG. 1, the basic pipe structure 11 is formed by three fiber composite layers 5, 7, 9. These fiber composite layers 5, 7, 9 can be conventional plastics reinforced with glass fibers or carbon fibers (GFRP or CFRP), for example. The basic pipe structure 11 or fiber composite layers 5, 7, 9 can comprise or be formed by prepregs, for example, and can have different laying directions (e.g., +/−45° relative to the pipe longitudinal direction).

The pipe 10 furthermore comprises a thermal insulation layer 15 on the outside 13 of the heat-generating ply 16. The insulating layer 15 can be formed by a foam material with a low thermal conductivity, for example. The thermal insulating layer 15 decouples the pipe 10 thermally almost completely from a structure supporting the pipe 10.

The heat-generating ply 16 comprises at least one fiber composite layer 20, which, for its part, has fibers and a matrix surrounding the fibers (not shown specifically). In contrast to conventional plastics reinforced with glass fibers or reinforced with carbon fibers, at least some of the fibers in the at least one fiber composite layer 20 are formed as conducting fibers 22 (cf. FIG. 2). For this purpose, the conducting fibers 22 are formed as carbon fibers 24 with an electrically insulating coating 26. The conducting fibers 22 can be used as electric conductors and thus as electric heating elements for heating the pipe 10. In this case, the conducting fibers 22 are integrated into the pipe 10, wherein a power source 46 (cf. FIG. 3) can be applied to the conducting fibers 22 in order to pass a heating current through the fibers. By virtue of the electrically insulating coating 26 of the conducting fibers 22, leakage currents are avoided. The conducting fibers 22 can also touch and, at the same time, can serve not only as current conductors but simultaneously also as reinforcing fibers for the fiber composite layer 20.

The electrically insulating coating 26 illustrated in FIG. 2 can have a thickness in a range of from 0.1 micrometer to 1 micrometer. The carbon fibers 24 can have a diameter of between 6 and 7 micrometers, for example, giving a diameter of the conducting fibers 22 of about 7 to 8 micrometers. The electrically insulating coating 26 is formed as a polymer electrolyte coating, for example. Polymer electrolyte coatings of this kind can have a temperature stability of at least 700 degrees Celsius but, at the same time, can have excellent bonding properties for incorporation into fiber-reinforced components.

FIG. 3 shows a pipe heating system 40 for an aircraft, wherein, by way of simplification and by way of example, only the fiber composite layer 20 with the conducting fibers 22 in a “rolled up” view is illustrated. The pipe heating system 40 comprises the power source 46 for supplying electric heating power. The power source 46 is connected in an electrically conductive manner to the fiber composite layer 20. The pipe heating system 40 furthermore has a control unit 50 having temperature sensors 48, by means of which the heating power of the power source 46 can be controlled. By means of the control unit 50, the current conducted electrically in the conducting fibers 22 can be continuously adapted if there is a deviation from a desired target temperature and there is a desire to compensate the deviation.

The conducting fibers 22 are integrated into the fiber composite layer 20 in such a way that the conducting fibers 22 protrude from the fiber composite layer 20 and can be electrically connected at the start of the pipe or at the end of the pipe. The conducting fibers 22 form a closed circuit 30, wherein the power source 46 is connected in an electrically conductive manner to the closed circuit 30.

In FIG. 3, the conducting fibers 22 forming the closed circuit 30 are selected and illustrated in the fiber composite layer 20 purely by way of example in the form of a meandering and continuous individual fiber 22. Although, in FIG. 3, the continuous individual fiber 22 is illustrated by way of example as spaced apart in the mutually parallel longitudinal sections, it is possible to place the continuous individual fiber 22 so close together, at least in some section or sections, that it corresponds to unidirectional alignment of the conducting fibers 22. The conducting fibers 22 are then aligned unidirectionally. It is then possible, in particular, for the conducting fibers 22 to be arranged parallel to the pipe longitudinal direction 6 (cf. FIG. 1). As an alternative, the form of the arrangement of the conducting fibers 22 in the fiber composite layer 20 can be selected from the group comprising: fiber bundles, fiber ribbons, non-crimped fibers, fiber mats, woven fibers or nonwoven fibers. It is then also possible in principle to implement a multiplicity of closed circuits 30 for heating the pipe 10.

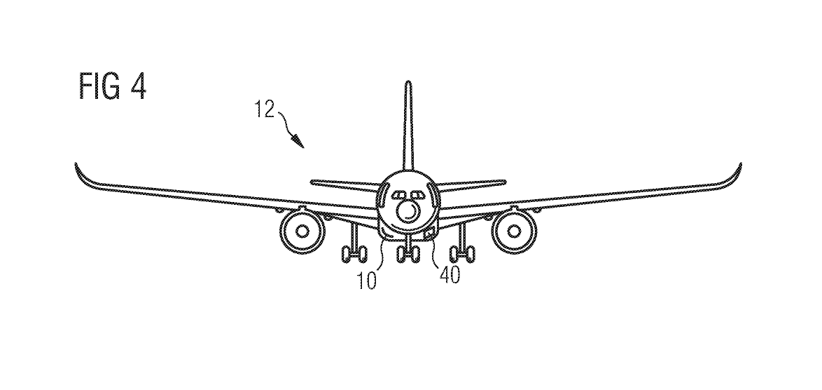

FIG. 4 illustrates the aircraft 12 having the heatable pipe 10 or the pipe heating system 40. The heatable pipe 10 or pipe heating system 40 provides a multifunctional and lightweight solution for use in commercial aircraft, particularly in unheated areas of commercial aircraft. By virtue of the relatively small number of individual components, the pipe 10 or pipe heating system 40 can furthermore be produced or manufactured easily and quickly. The direct integration of the heating capability into the pipe 10 also allows quick and easy installation.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A heatable pipe for an aircraft, comprising
a heat-generating ply, which extends in a pipe circumferential direction and a pipe longitudinal direction, at least in some section or sections,
wherein the heat-generating ply comprises a fiber composite layer containing fibers and a matrix surrounding the fibers,
wherein at least some of the fibers are formed as conducting fibers, and
wherein the conducting fibers are formed as carbon fibers with an electrically insulating coating.

2. The pipe according to claim 1, wherein the conducting fibers form one or more closed circuits.

3. The pipe according to claim 1, wherein a form of an arrangement of the conducting fibers in the fiber composite layer is selected from a group consisting of: individual fibers, fiber bundles, fiber ribbons, non-crimped fibers, fiber mats, woven fibers and nonwoven fibers.

4. The pipe according to claim 1, wherein the conducting fibers are aligned in a unidirectional manner.

5. The pipe according to claim 1, wherein the conducting fibers are arranged parallel to the pipe longitudinal direction.

6. The pipe according to claim 1, wherein the heat-generating ply is arranged on a pipe inner side.

7. The pipe according to claim 1, wherein the electrically insulating coating has a thickness in a range of from 0.1 micrometer to 1 micrometer.

8. The pipe according to claim 1, wherein the conducting fibers are integrated into the fiber composite layer in such a way that the conducting fibers protrude from the fiber composite layer at a beginning of the pipe or at an end of the pipe.

9. The pipe according to claim 1, wherein the electrically insulating coating is formed as a polymer electrolyte coating.

10. A pipe heating system for an aircraft, comprising:
a. a heatable pipe according to claim 1,
b. a power source for supplying electric heating power,
wherein the power source is connected electrically to the conducting fibers.

11. The pipe heating system according to claim 10, furthermore comprising a control unit which comprises temperature sensors and by means of which the heating power of the power source can be controlled.

12. An aircraft comprising a pipe heating system according to claim 10.
